(19) United States
(12) Patent Application Publication
(10) Pub. No.: US 2009/0086722 A1
(43) Pub. Date: Apr. 2, 2009

(54) COMMUNICATION APPARATUS AND TERMINAL REGISTRATION METHOD FOR USE IN COMMUNICATION SYSTEM

(75) Inventor: Takanori Kaji, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/205,675

(22) Filed: Sep. 5, 2008

(30) Foreign Application Priority Data
Sep. 28, 2007 (JP) 2007-256239

(51) Int. Cl. H04L 12/66

(52) U.S. Cl. 370/352; 379/90.01

(57) ABSTRACT

According to one embodiment, a communication apparatus includes an agent server module configured to connect to the telephone terminal connected to the public network, while bypassing the public network and the private network, and configured to receive a registration request including the terminal ID of the telephone terminal from the telephone terminal, and a controller which performs registration processing based on the registration request received by the agent server module via the bypass, and generates a session for terminal control with respect to the telephone terminal of a requester via the NAT router.

### CROSS-REFERENCE TO RELATED APPLICATIONS

This application is based upon and claims the benefit of priority from Japanese Patent Application No. 2007-256239, filed Sep. 28, 2007, the entire contents of which are incorporated herein by reference.

### BACKGROUND

1. Field

One embodiment of the present invention relates to a communication apparatus for use in a communication system in which, for example, an internet protocol (IP) telephone set can be registered by the registration processing of a voice over internet protocol (VOIP) via a public network such as an IP network, and it also relates to a terminal registration method for use in the communication system.

2. Description of the Related Art

In recent years, an IP telephone system which bidirectionally transmits and receives image and voice as packet data in real time via an IP network has started to prevail. In this IP telephone system, needless to say, communication between extensions, and transmission and reception of calls via outside lines can be performed for each exchange apparatus connected to the IP network. In addition, communication between extensions, and transmission and reception of calls via outside lines can be performed between the exchange apparatuses via the IP network.

In particular, in a corporation having a plurality of branch offices and service offices, the exchange apparatuses are installed in the branch offices or the service offices, respectively, and these exchange apparatuses are connected to one another via the IP network.

In a general corporation network, public addresses are assigned only to the addresses of a server and a router which are opened to the outside and a firewall apparatus. For the others, a local area network as a private network is constituted via a network address translator (NAT) apparatus. Such a network is connected to the IP telephone system which has a plurality of network interfaces and in which IP terminals are dispersive accommodated in the respective interfaces in order to disperse loads, to construct a system to which an IP telephone terminal is connected from any network outside the corporation. In this case, the public address needs to be assigned to each telephone server.

It is to be noted that in a case where an SIP method is extracted from a packet received from a public network side and the method is a register, a technique is considered which uses an address conversion apparatus for registering the requester IP address of the SIP packet as an IP address in an address conversion table (e.g., Jpn. Pat. Appln. KOKAI Publication No. 2006-211601).

In addition, a system has heretofore strongly been demanded in which capital investment can further be decreased and to which the IP telephone terminal is connected from any network outside the cooperation by a simple processing procedure.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing a communication system according to a first embodiment of the present invention;

FIG. 2 is a diagram showing one example of contents stored in a database shown in FIG. 1;

FIG. 3 is a sequence diagram showing an operation of establishing a control session for registration between an IP telephone terminal and a main apparatus in the first embodiment; and

FIG. 4 is a schematic constitution diagram showing a communication system according to a second embodiment of the present invention.

### DETAILED DESCRIPTION

Various embodiments according to the invention will be described hereinafter with reference to the accompanying drawings. In general, according to one embodiment of the invention, a communication apparatus which is connected to a private network, configured to connect to a public network arranged in a band broader than that of the private network via a network address translator (NAT) router, and configured to provide an IP telephone service to a telephone terminal accommodated by a known voice over internet protocol (VOIP) registration procedure, the communication apparatus comprising: an agent server module configured to connect to the telephone terminal connected to the public network, while bypassing the public network and the private network, and configured to receive a registration request including the terminal ID of the telephone terminal from the telephone terminal; and a controller which performs registration processing based on the registration request received by the agent server module via the bypass, and generates a session for terminal control with respect to the telephone terminal of a requester via the NAT router.

### First Embodiment

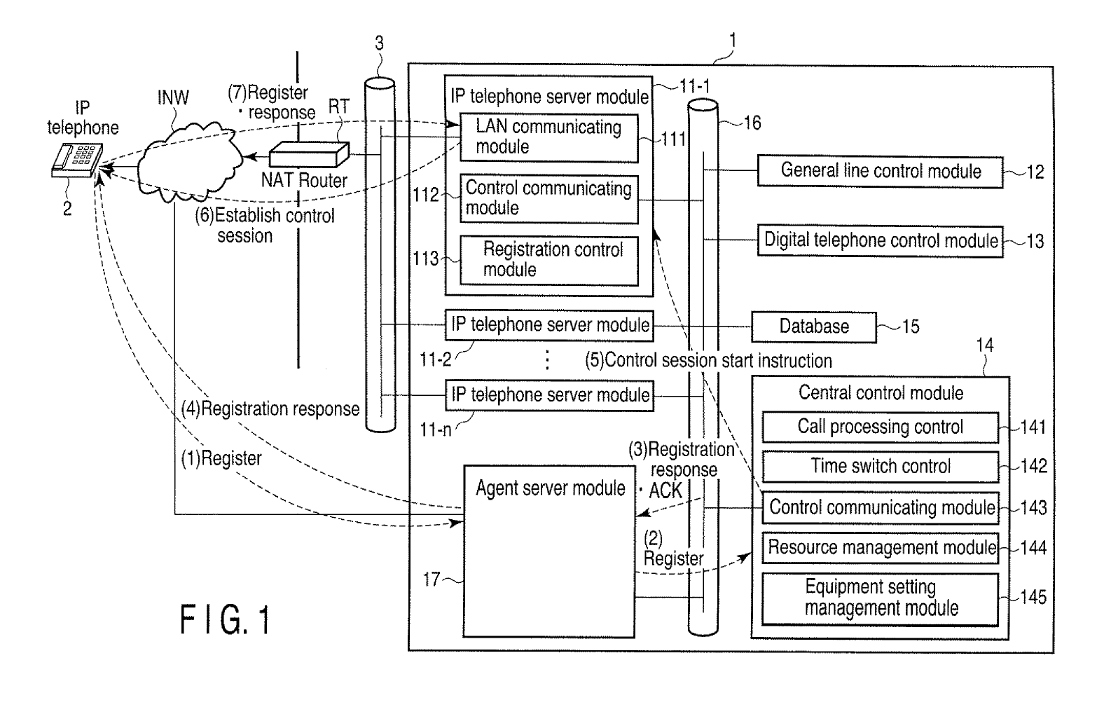

FIG. 1 is a block diagram showing the constitution of a communication system according to a first embodiment of the present invention. In the drawing, reference numeral 1 is a main apparatus and 2 is an IP telephone terminal.

The main apparatus 1 includes a plurality of IP telephone server modules 11-1 to 11-n (n is a natural number) as interface modules, a general line control module 12, a digital telephone control module 13, a central control module 14 and a database 15, and these IP telephone server modules 11-1 to 11-n, the general line control module 12, the digital telephone control module 13, the central control module 14 and the database 15 are connected to one another via a control bus 16. Moreover, the plurality of IP telephone server modules 11-1 to 11-n are connected to one another via an LAN 3.

Furthermore, the plurality of IP telephone server modules 11-1 to 11-n are connected to a public network INW such as internet arranged in a band broader than that of the LAN 3, via the LAN 3 and an NAT router RT, and the modules are further connected to the IP telephone terminal 2 via this public network INW.

In addition, the plurality of IP telephone server modules 11-1 to 11-n accommodate the IP telephone terminals on the LAN 3 registered in the database 15, and provide IP telephone services such as the processing of outgoing calls and incoming calls from and to the IP telephone terminals.

The general line control module 12 is connected to, for example, an analog public network (not shown), and performs processing to establish calls between the module and the analog public network and the like.

The digital telephone control module 13 accommodates a plurality of digital extension terminals (not shown). For example, a digital key telephone set is used as the digital extension terminal. The digital telephone control module 13 performs the processing of outgoing calls and incoming calls from and to the digital extension terminals, digital signal transfer processing and the like.

The central control module 14 includes a usual call processing control module 141 for controlling outgoing call processing accompanying the calling request of each digital extension terminal, usual incoming call processing accompanying incoming calls via outside lines from the analog public network, transfer processing between the digital extension terminals and the like. In addition, the central control module includes a time switch control module 142, a control communicating module 143, a resource management module 144 and an equipment setting management module 145.

The time switch control module 142 performs switching connection between the plurality of IP telephone server modules 11-1 to 11-n and the general line control module 12 and digital telephone control module 13.

The control communicating module 143 executes communication processing between the plurality of IP telephone server modules 11-1 to 11-n and the general line control module 12 and digital telephone control module 13.

The resource management module 144 manages the resource states of the plurality of IP telephone server modules 11-1 to 11-n.

Additionally, in this first embodiment, the main apparatus 1 is provided with an agent server module 17 which can be connected to the public network INW, bypassing the NAT router RT and the LAN 3. This agent server module 17 is connected to the control bus 16, and receives a registration request (register) from, for example, the IP telephone terminal 2 to notify the central control module 14 of this register. The central control module 14 determines, for example, the IP telephone server module 11-1 in accordance with the resource states of the IP telephone server modules 11-1 to 11-n managed by the resource management portion 144 or setting conditions set by the equipment setting management portion 145, to send a control session start instruction to this IP telephone server module 11-1.

On the other hand, the IP telephone server module 11-1 includes an LAN communicating module 111 for establishing a control session for terminal control between the module and the IP telephone terminal 2, a control communicating module 112 for performing communication between the module and the central control module 14, and a registration control module 113.

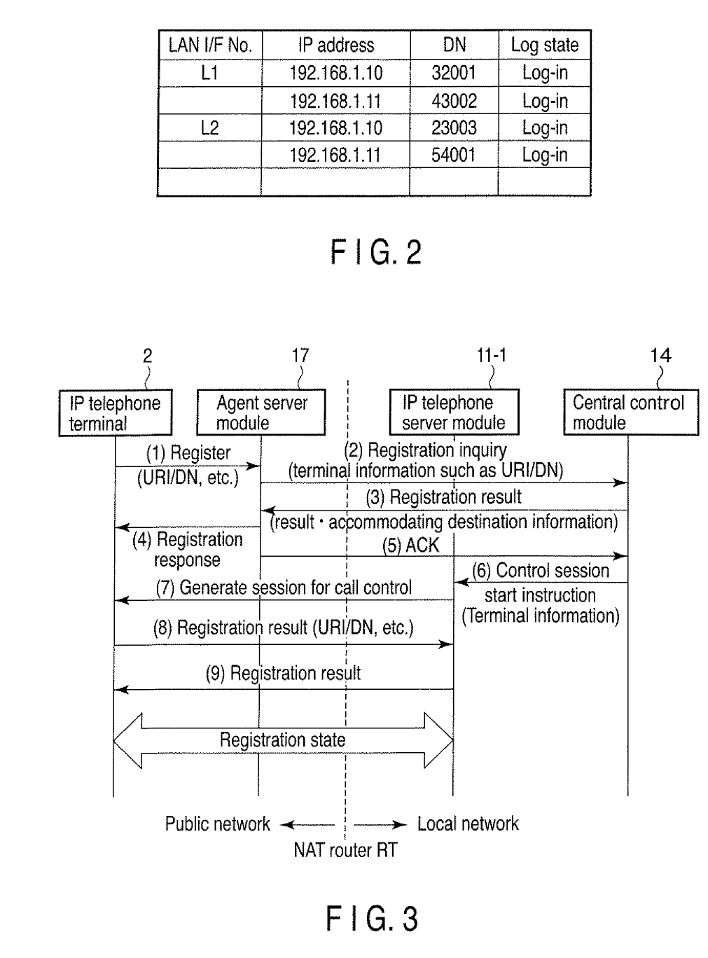

As shown in FIG. 2, the registration control module 113 associates the IP address, DN and log-in state of the IP telephone terminal 2 as a requester with the LAN interface number of the IP telephone server module 11-1, to register the IP address and the like.

The IP telephone terminal 2 is similar to a usual IP telephone set except that a stand-by port is opened so that a packet from a server side can be received during the registration.

Next, the operation of the system having the above constitution will be described.

FIG. 3 is a sequence diagram showing an operation of establishing the control session between the main apparatus 1 and the IP telephone terminal 2 by use of the registration procedure of a voice over internet protocol (VOID).

To register the IP telephone terminal 2 in the database 15, a user of the IP telephone terminal 2 performs an outgoing call operation by use of the public address of the agent server module 17. Then, the IP telephone terminal 2 generates a register for the agent server module 17 to transmit this request to the public network INW (FIG. 3(1)).

On receiving the register, the public network INW calls the agent server module 17 as a receiver. Then, when the agent server module 17 receives this call to respond to the call, communication link is formed between the IP telephone terminal 2 and the agent server module 17.

The agent server module 17 inquires the central control module 14 of the main apparatus 1 of the accommodation situations of the IP telephone server modules 11-1 to 11-n. In this case, terminal-side information (URI/DN/address/port, etc.) is notified (FIG. 3(2)).

The central control module 14 determines the accommodating destination of the IP telephone terminal 2 which has sent the request in accordance with the vacancy information of the resources of the IP telephone server modules 11-1 to 11-n or setting contents, to return a registration result to the agent server module 17 (FIG. 3(3)).

The agent server module 17 notifies the IP telephone terminal 2 as the requester of the result, and returns acknowledgement ACK to the central control module 14 (FIG. 3(4), (5)).

On receiving the ACK, the central control module 14 instructs the corresponding IP telephone server module 11-1 to generate the control session (FIG. 3(6)).

On receiving the instruction, the IP telephone server module 11-1 generates the session for call control with respect to the IP telephone terminal 2 (FIG. 3(7)).

Subsequently, usual registration processing is executed with respect to the generated session between the IP telephone terminal 2 and the IP telephone server module 11-1. Afterward, the information of the IP telephone terminal 2 is registered in the database 15 (FIG. 3(8), (9)).

As described above, the registration or log-in from the outside of the NAT router RT can be performed with respect to the main apparatus 1 connected to the inside of the NAT router RT. It is to be noted that a case where IP telephone control is started at the time of FIG. 3(6) is also considered.

As described above, in the first embodiment, the main apparatus 1 is provided with the agent server module 17 which can be connected to the public network INW, bypassing the NAT router RT and the LAN 3. The IP telephone terminal 2 on the public network INW transmits the register to the database 15 by use of the public address assigned to the agent server module 17, and the agent server module 17 receives the register to notify the central control module 14 of the request. Then, the central control module 14 determines the optimum IP telephone server module 111 in accordance with the resource states of the plurality of IP telephone server modules 11-1 to 11-n, or the setting conditions, and this IP telephone server module 11-1 establishes the session for control to the IP telephone terminal 2 as the requester via the LAN 3, the NAT router RT and the public network INW.

Therefore, the IP telephone terminal 2 on the side of the public network INW can register the terminal information in the database 15 of the main apparatus 1 by use of one public address. Moreover, the public addresses do not have to be assigned to the IP telephone server modules 11-1 to 11-n, respectively. In consequence, only one interface requires the public address.

### Second Embodiment

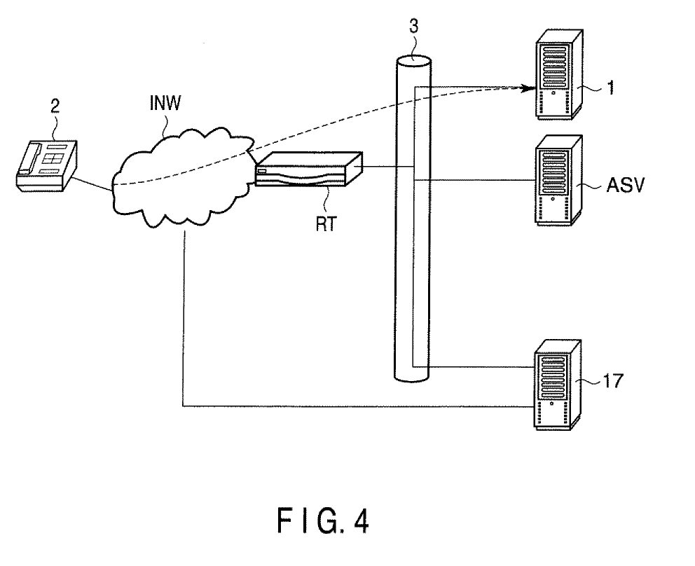

FIG. 4 is a schematic constitution diagram showing a communication system according to a second embodiment of the present invention. In FIG. 4, the same part as that of FIG. 1 is denoted with the same reference numerals, and the detailed description thereof is omitted.

This second embodiment has a constitution in which a main apparatus 1 and an agent server module 17 are dispersed on an LAN 3. Furthermore, the LAN 3 is connected to an application server ASV.

The main apparatus 1 has a usual control function of controlling communication processing and the like between the application server ASV and agent server module 17 on the LAN 3 and another communication equipment.

As described above, even in the second embodiment, function and effect similar to those of the first embodiment can be obtained. Moreover, the main apparatus 1 and the agent server module 17 are separately connected to the LAN 3. Therefore, during the maintenance or the like of the agent server module 17, a main apparatus 1 main body does not have to be repaired.

### Other Embodiment

This invention is not limited to the above embodiments, and the constitution of a communication system, the functional constitution of a main apparatus, the type of a communication apparatus such as the main apparatus, a registration control procedure and the contents of the procedure can variously be modified and implemented without departing from the scope of this invention.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication apparatus which is connected to a private network, configured to connect to a public network arranged in a band broader than that of the private network via a network address translator (NAT) router, and configured to provide an IP telephone service to a telephone terminal accommodated by a known voice over internet protocol (VOIP) registration procedure, the communication apparatus comprising:
an agent server module configured to connect to the telephone terminal connected to the public network, while bypassing the public network and the private network, and configured to receive a registration request including the terminal ID of the telephone terminal from the telephone terminal; and
a controller which performs registration processing based on the registration request received by the agent server module via the bypass, and generates a session for terminal control with respect to the telephone terminal of a requester via the NAT router.

2. The communication apparatus according to claim 1, further comprising:
a plurality of interface modules connected to the private network,
wherein the controller selects the interface module in which the telephone terminal of the requester is accommodated based on the register, and instructs this interface module to generate the session to the telephone terminal of the requester.

3. The communication apparatus according to claim 2, wherein the controller selects the interface module in which the telephone terminal of the requester is accommodated based on the resource states of the plurality of interface modules or predetermined conditions in addition to the registration request.

4. A terminal registration method for use in a communication system including a telephone terminal connected to a public network, and a communication apparatus which is connectable to this telephone terminal via a network address translator (NAT) router and a private network arranged in a band narrower than that of the public network and which provides an IP telephone service to the telephone terminal accommodated by a known voice over internet protocol (VOIP) registration procedure, the method comprising:
transmitting a registration request including terminal ID to an agent server module configured to connect to the telephone terminal, while bypassing the public network and the private network, the terminal ID specifies the telephone terminal;
transmitting the registration request to the communication apparatus in the agent server module;
performing registration processing with respect to the telephone terminal of a requester based on the registration request in the communication apparatus; and
generating a session for terminal control via the NAT router with respect to the telephone terminal of the requester.
